(19) United States
(12) Patent Application Publication
(10) Pub. No.: US 2004/0100108 A1
(43) Pub. Date: May 27, 2004

(54) Device to pick up excrements of pets and to safely handle hazarduos objects, placing them into a disposable bag

(76) Inventors: Juan Manuel Cappellano, San Miguel (AR); Carlos Alberto Cappellano, San Miguel (AR)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/445,714

(22) Filed: May 27, 2003

(30) Foreign Application Priority Data
Nov. 25, 2002 (AR) P020104515

(51) Int. Cl. A01K 29/00

(52) U.S. Cl. 294/1.3

(57) ABSTRACT

DEVICE TO PICK UP EXCREMENTS OF PETS AND TO SAFELY HANDLE HAZARDUOS OBJECTS, PLACING THEM INTO A DISPOSABLE BAG, consisting of a hollow handle (4), inside which axially displaces a rod (3), travelling from a rest position towards its operative position, having at its lower free end of said rod two jaws (5) in which said jaws (5) may be pressed the one towards the other to retain the bottom end of an overturned bag (13), being this bag free to be released when said jaws are opened.

The device has a bell shaped body (7), inside of which is axially displaceable a tubular body (6), biased towards its rest position by elastic means (15-17). This tubular body (6) has at its lower edge a frusto-conical surface (6a), while the outer external surface of (6) is defining a seat a surface where it seats an elastic band, which is expelled by the lower edge (7b) of lateral wall of the bell shaped body (7), when said tubular body (6) slides within this bell shaped body (7), thus liberating an elastic annular band (14) placed on the outer surfaces of the tubular body (6) and abutting said lower edge (7b), causing this elastic band when free from its seat, an action of sweeping off the surface of the area contained by this bell shaped body (7), placing any object found in its seeping path into said bag and closing the lateral walls of bag (13).

This invention is relative to a device to pick up and to place into a disposable bag the excrements of pets.

### FIELD OF APPLICATION OF THIS INVENTION

The present invention finds its field of application field in collecting and placing into a disposable bag the excrements of domestic animals, such as a gods and cats, and in the handling of hazardous objects, such as glass shreds, or the like, without having a direct contact with them, providing an hygienic and secure pick-up operation, either within given premises or in the open, such as in a street or park.

### STATE OF THE ART

At present the Municipal Administrations of several cities are distributing small bags made out of polymeric film, with the purpose of allowing the owner of the pet undergoing its periodic walks, to retrieve its excrements deposited on the sidewalks or parks, by introducing its hand inside the bag and to pick up this waste. This operation bears not very pleasing aspects and it is very resisted by the users.

Another of the modalities in use for the retrieving and disposal of the depositions of the pets, consists on taking along with pet a small shovel and brush, or equivalent instrument and to the same effect. The inconvenience of using this instrument resides mainly in the hygiene, because the employed instruments gets dirty and they result contaminated.

Lately diverse devices have been created to fulfill these ends, such as devices that present two opposed jaws accionable from the upper end of a rod. These devices also are showing problems of doubtful hygiene, since during their operation they become soiled and contaminated.

They are also known devices integrated by an end profiled as a shovel, which is covered by a disposable bag and automatically capable of sweeping the droppings, placed between this shovel end and another disposable bag. The inconvenience this known device has is that for each operation, two different bags should be set and used, while the bag containing the droppings must be removed and closed manually, thus presenting the same hygiene problems, while it is not what can be termed as “user friendly”.

### PROBLEMS TO BE SOLVED

Undoubtedly, so much for hygiene as for aesthetics reasons, it is extremely desirable to have a device that is able to place into a bag the pet's droppings and other objects prone to provoke injuries during its handling, maintaining the performing device absolutely clean and uncontaminated, being this device able to perform the collection into the bag and closing of said without the direct intervention or contact with the user's hands.

### OBJECTS OF THE PRESENT INVENTION

It is a first object of the present invention to provide device able to hold a disposable bag capable to cover said device both on its inner and outwards surfaces, and is further able to place into said bag the refuse by means of a single operation, without the direct intervention of the hands of the user in said handling operations of this bag;

It is also an object of the present invention a disposable bag that is able to maintain under conditions of hygiene and cleanness the device in itself, as well as the hands of the user;

It is another object of this same invention the sweeping of the waste is performed by an intermediate portion within the inner surface of said discardable bag;

Last, it is also an object of the invention a device that has a single mobile element, which in a single mechanical operation under the distanced control of the operator is able to perform the above-mentioned sweeping operations, to pocket the refuse and to close said bag.

### BRIEF REVIEW OF THE INVENTION

DEVICE TO PICK UP EXCREMENTS OF PETS AND TO SAFELY HANDLE HAZARDUOS OBJECTS, PLACING THEM INTO A DISPOSABLE BAG, characterized: by a hollow handle having its upper end free and its lower end attached to a bell shaped body; inside this hollow handle is placed a rod which is axially free to travel within said handle, which at its upper end is linked to displacement means, operating this rod from a position of rest to a position of axial displacement toward the interior of this bell shaped body, being the lower end of said rod within said bell shaped body attached to retention means of the closed end of a bag, when this rod is to be found in its resting position in which this retention means are closed, while the axial displacement of this rod defines the opening of this retention means, liberating said end of the bag; this bell shaped body has lateral walls substantially perpendicular to the floor and within said lateral walls and adjacent to its inner surfaces there is a coaxial tubular body, which is axially displaceable within said bell shaped body; this coaxial tubular body is opened at both ends and is defined by walls parallel to said lateral walls of said bell shaped body, being the cross section of this tubular body complementary to the cross section of said bell shaped body; this tubular body has a resting position in which its lower end extends out from the lower edge of said bell shaped body, having the outermost free end of this tubular body a frusto-conical surface sloping toward the central axis of the device; this tubular body moves axially inside this bell shaped body until its free sloping edge is aligned on a same plane with the lower free edge of said bell shaped body; this said tubular body is permanently biased toward its rest position by an elastic means reacting against the upper inner surfaces of said bell shaped, forming said lower end of said bell shaped body a shoulder means placed adjacent to the external surface of this tubular body, thereby defining extraction means for an elastic annular element applied in its resting position on the external surface of said tubular body, providing this shoulder with means that dislodge said annular element towards said sloped surfaces upon the axial travel of said tubular body within said bell shaped body; being the mentioned bag placed with its open end downwards and retained from its closed end by said retention means within said bell shaped body, having this bag its open end upturned and adjacent to the external surface of the tubular body and bell shaped body, covering to the mentioned annular element, which defines the means of sweeping of the surface portion contained within the area of tubular body, further determining said annular elastic element the closing means of the said bag.

### PREFERRED EMBODIMENTS OF THE PRESENT INVENTION

In order to be able to exemplify the favorite embodiment examples of the present invention, the following drawings are attached, in support of the description of this instant invention, which, should not be interpreted to have any limiting value, being the scope of this instant invention included within the reach of the first claim attached in the corresponding chapter of claims.

In these Figures, the same references identify the same or equivalent means.

FIG. 1 is a lateral perspective from below of a construction of the invention, without the bag;

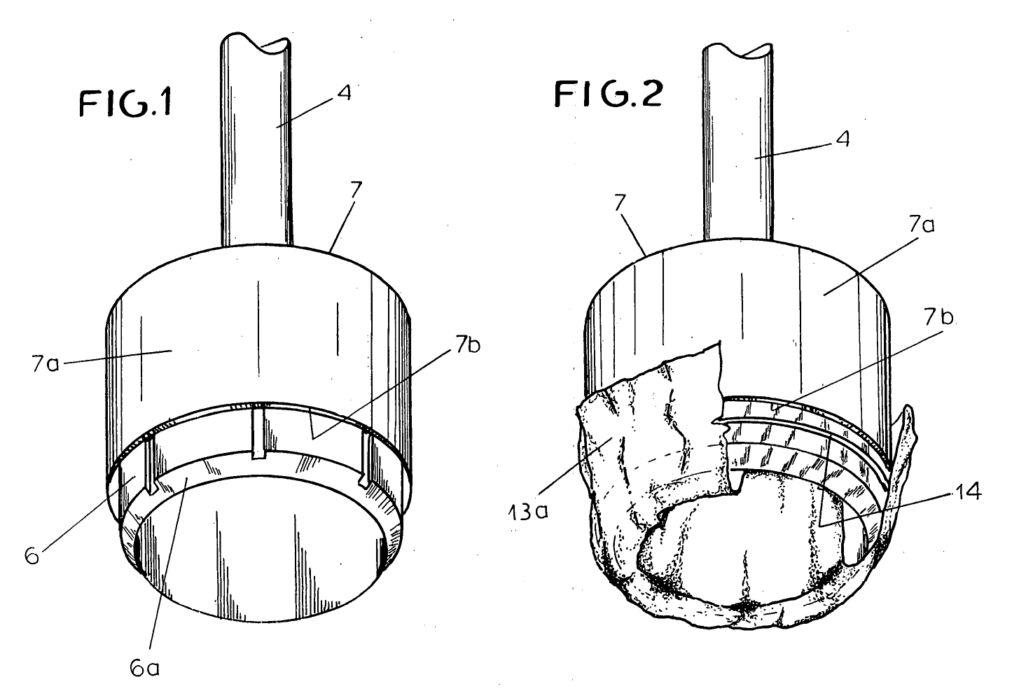

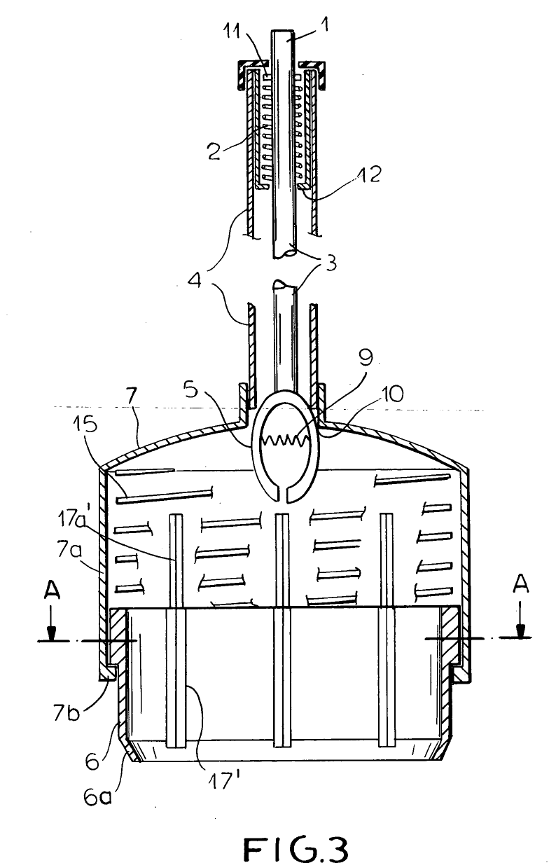

FIG. 2 illustrates a similar lateral perspective of this same device, but with the bag already installed and ready for its employment;

FIG. 3 shows a vertical cross section of an embodiment of the invention, without the bag;

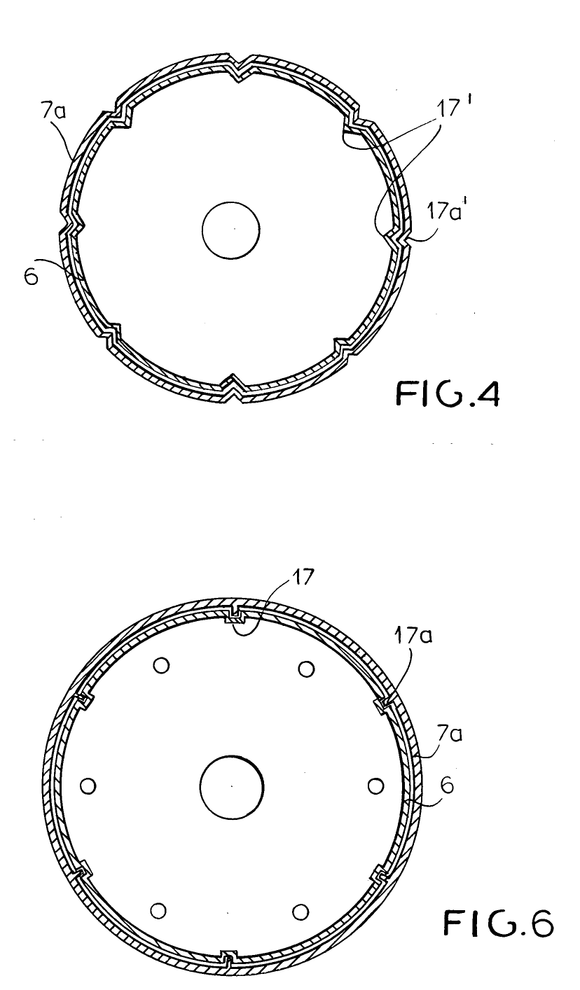

FIG. 4 depicts section AA of FIG. 3;

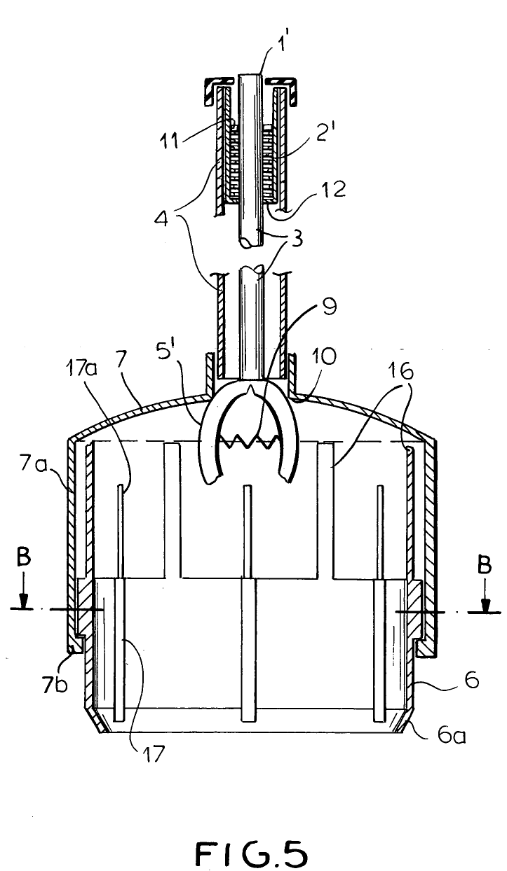

FIG. 5 shows a vertical cross section of yet another embodiment of the invention, without the bag;

FIG. 6 depicts section BB of FIG. 5;

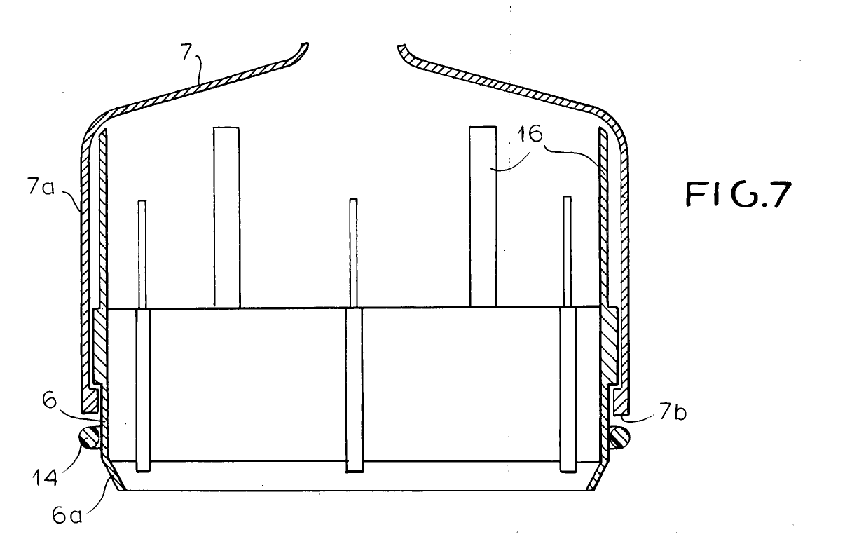

FIG. 7 shows an enlargement of FIG. 5 cross section, with the bag in its position prior to the employment of the device, and

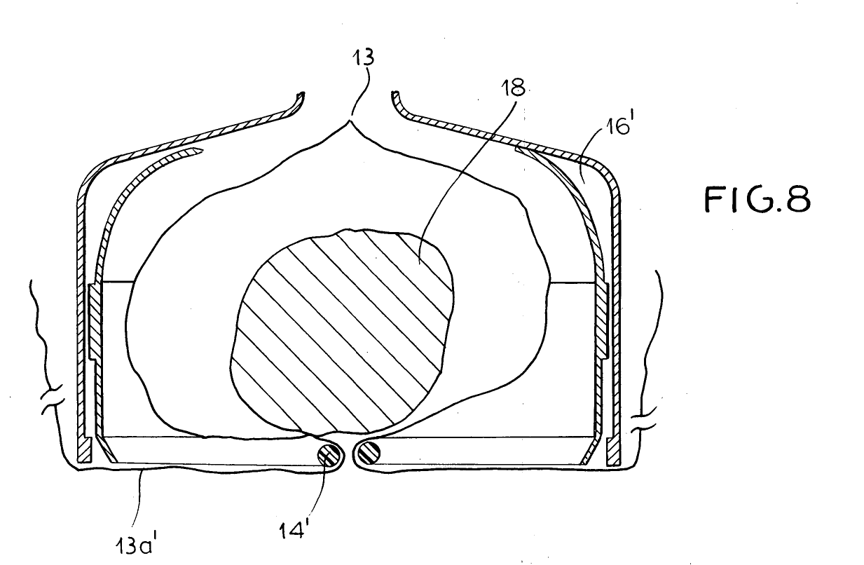

FIG. 8 shows the device in its operative position, having performed the sweeping operation, pocketed placing into the bag the excrements and the bag already closed.

In said Figures, reference (4) indicates a hollow handle, which is joined to a bell shaped body (7). Inside this handle there is a rod (3) (see FIGS. 3 and 5) which is operatively linked at its lower end to two opposed pincers or jaws (5), emerging within the upper inner vault of the volume contained by this bell shaped body (7) and pressed against portions (10) thereof.

This rod (3) is able to be axially displaced inside said handle (4) between two selective operative positions by the action of a displacing means (see FIG. 3), namely from its rest position in which said pincers are found in a closed imprisonment position, to its operative position in which (see FIG. 5) said rod is downwards displaced down, in which said pincers are found at their open position (5′) or liberation position. The pincers preferably have an elastic means (9) biasing said pincers towards their open position when the rod (3) is depressed, and they close when said rod (3) is risen and said parts (10) of the inner vault is pressing said pincers to their closed position.

Different means may be used for the displacement of this rod (3), but it is preferred the means shown at FIGS. 3 and 5, that is, a press button (1) joined to the end of said rod (3) and emerging at the upper end of the handle (4). Either this press button (1) or a portion of said rod have a first washer or salient (11), which will press upon a helical compression spring (2), which seats upon a fixed projection (12) inside this handle (4). In their operative resting state, this spring (2) is biased outwards of its seat within the handle this press button (1), and in this position the opposed pincers (5) will close. When this press button is pressed to its position (1′), (see FIG. 5), it displaces downwards said rod (3), compressing the spring in (2′) causing said jaws or pincers (5) to open up, liberating the bottom of the bag (13) (to See FIG. 8), retained by these jaws (5).

This bell shaped body (7) has a lateral wall (7a), which may be substantially vertical, and in the preferred embodiments these lateral wall (7a) is a cylindrical wall, though nothing prevents to consider a body (7) having prismatic walls and a polygonal section. Inside this lateral wall (7a) and coaxial to it we fined a tubular body (6), opened at both ends.

This tubular body (6) it is axially displaced inside the mentioned lateral wall (7a) from its resting position (see FIG. 7), in which this body (6) emerges coaxially outwards from the lower end of said lateral wall (7a) presenting a portion of wall (6) and a lower end which is frusto-conical in shape, defining a sloped surface (6a), to its operative position (see FIG. 8), in which the emerging wall portion of (6) is completely housed within said lateral wall (7a), and the lower end (6a) of (6) is placed at the same level with the lower edge (7b) of the lateral wall (7a).

In FIG. 2 it is shown the device object of this invention in its resting position, and with a bag already installed on it, being this bag shown partially in section. This bag, as already said, has its closed bottom end (13) retained by the jaws (5), while the lateral parts thereof (13a) are rebutted over the ending edge (6a) of the tubular body (6) and placed against the external surface of the lateral wall (7a), while also covering an elastic band or the like (14).

This tubular body (6) is constantly biased towards its resting position, that is to say extended outside from the lower end of lateral wall (7a), by the action of elastic means.

FIG. 3 shows the elastic means biasing the tubular body determined by an helical spring (15), while the embodiment of FIG. 5 shows said elastic means determined by thin straight strips (16), integral to the upper end of said tubular body (6) and projecting thereof, being these thin strips (16) capable of elastic deformation when sliding against the internal vault of the inner dome surface of the bell shaped body (7).

Preferably these thin straight strips (16) are projecting from said upper end of body (6) conforming a crown.

This tubular body (6) may also have rectilinear displacement guide means guiding the axial sliding movement of said body (6) in regards to the bell shaped body (7), being these guide means composed by channels (17) of complementary square and salient cross section (17a) that slides into these channels, as shown at FIGS. 5 and 6, or channels of triangular cross section (17′) and complementary salient (17a′) sliding into these channels, as shown at FIGS. 3 and 4.

### How this Invention Works

The working of the present invention is better explained with the aid of the FIGS. 7 and 8.

FIG. 7 depicts an enlargement of the lower portion of this device, at its resting state, according to the embodiment as per FIG. 5, shown without bag (13) for reasons of clarity, but it is understood that this bag is installed just as it shown at FIG. 2.

When the pet's droppings (indicated with reference 18) or e.g. broken pieces of glass shreds are wished to be picked up from the floor, the bell shaped body (7) is positioned over (18) covering it. Then the device is pressed downwards, therefore the bell shaped (7) descends since the lower ends of the tubular body (6) will be pushed axially within said body (7). Upon said axial travel of the tubular body (6), the elastic band (14) abuts against the lower edge (7b) of the bell shaped body (7), which acts as an ejecting means for the elastic band (14), which is forced to slip over the sloped surface (6a), and upon reaching the lower edge of (6a) said elastic band (14) is free to snap-close tightly at (14′) around the sides (13a) of bag (13), and at the same time producing a sweeping action of the enclosed area within said bell shaped body forcing the droppings (18) or the intended pieces of glass, china, etc, to be collected and enclosed with said bag (13).

It is to be noticed the total cleanness and hygiene of the operation, because the internal walls of (13a) of bag (13) they are preserving the inner and outer surfaces of the device from any contact with the droppings, while the portion of the bag performing the sweeping action upon the liberation of the elastic band (14) remains turned towards the inside of the bag:

1- DEVICE TO PICK UP EXCREMENTS OF PETS AND TO SAFELY HANDLE HAZARDUOS OBJECTS, PLACING THEM INTO A DISPOSABLE BAG, characterized: by a hollow handle having its upper end free and its lower end attached to a bell shaped body; inside this hollow handle is placed a rod which is axially free to travel within said handle, which at its upper end is linked to displacement means, operating this rod from a position of rest to a position of axial displacement toward the interior of this bell shaped body, being the lower end of said rod within said bell shaped body attached to retention means of the closed end of a bag, when this rod is to be found in its resting position in which this retention means are closed, while the axial displacement of this rod defines the opening of this retention means, liberating said end of the bag; this bell shaped body has lateral walls substantially perpendicular to the floor and within said lateral walls and adjacent to its inner surfaces there is a coaxial tubular body, which is axially displaceable within said bell shaped body; this coaxial tubular body is opened at both ends and is defined by walls parallel to said lateral walls of said bell shaped body, being the cross section of this tubular body complementary to the cross section of said bell shaped body; this tubular body has a resting position in which its lower end extends out from the lower edge of said bell shaped body, having the outermost free end of this tubular body a frusto-conical surface sloping toward the central axis of the device; this tubular body moves axially inside this bell shaped body until its free sloping edge is aligned on a same plane with the lower free edge of said bell shaped body; this said tubular body is permanently biased toward its rest position by an elastic means reacting against the upper inner surfaces of said bell shaped, forming said lower end of said bell shaped body a shoulder means placed adjacent to the external surface of this tubular body, thereby defining extraction means for an elastic annular element applied in its resting position on the external surface of said tubular body, providing this shoulder with means that dislodge said annular element towards said sloped surfaces upon the axial travel of said tubular body within said bell shaped body; being the mentioned bag placed with its open end downwards and retained from its closed end by said retention means within said bell shaped body, having this bag its open end upturned and adjacent to the external surface of the tubular body and bell shaped body, covering to the mentioned annular element, which defines the means of sweeping of the surface portion contained within the area of tubular body, further determining said annular elastic element the closing means of the said bag.

2- DEVICE, according to claim 1, characterized by having this bell shaped body substantially cylindrical lateral walls, inside of which it axially displaces a cylindrical tubular body.

3- DEVICE, according to claim 1, characterized because this retention means are constituted by a couple of opposed jaws, biased towards their opened position by elastic means, being these jaws pressed against the inner walls of the dome of the bell shaped body forcing the closing of said jaws.

4- DEVICE, according to claim 1, characterized because the displacement means are in the nature of a push-button placed at the upper free end of the hollow handle, being this push button biased by an helical spring placed between a washer attached to said rod, and a projection of said handle against which it reacts.

5- DEVICE, according to claim 1, characterized by being said extractor means an enlargement of the lower end of the lateral wall of the bell shaped body, axially sliding adjacent and against the outer walls of the tubular body placed within said bell shaped body, being said elastic element an annular elastic band.

6- DEVICE, according to claim 1, characterized because the elastic means biasing the tubular body toward its extended resting position is a helical spring pressing against the upper inner edges of said tubular body and reacting against the inner upper surfaces of the dome of the bell shaped body.

7- DEVICE, according to claim 1, characterized in that said elastic means biasing said tubular body toward its extended resting position are a number of flexible longitudinal strips projected in crown form from the upper border of the tubular body and elastically reacting against the dome of the inner upper region of the bell shaped body.

8- DEVICE, according to claims 1 to 7, characterized because the tubular body has longitudinal groves placed into the inner side wall of the bell shaped body, with a cross section which is complementary of the cross section of longitudinal ribs extended on the outer surface of said tubular body, sliding said ribs within said groves.
